(19) United States
(12) Patent Application Publication
(10) Pub. No.: US 2018/0288305 A1
(43) Pub. Date: Oct. 4, 2018

(54) ELECTRONIC DEVICE AND CONTROLLING METHOD

(71) Applicant: CANON KABUSHIKI KAISHA, Tokyo (JP)

(72) Inventor: Hiroki Ota, Tokyo (JP)

(21) Appl. No.: 15/940,013

(22) Filed: Mar. 29, 2018

(30) Foreign Application Priority Data
Mar. 30, 2017 (JP) 2017-068741

(51) Int. Cl. H04N 5/232; H04N 5/225

(52) U.S. Cl. CPC H04N 5/23209; H04N 5/2251

(57) ABSTRACT

An electronic device includes a main module and sub modules. The sub modules includes a first sub module and a second sub module. The electronic device sets a unique communication address to the first sub module by performing communication between the main module and the first sub module using a common communication address, and changes a connection route between the first sub module and the second sub module from a disconnected state to a connected state after the unique communication address is set.

### BACKGROUND

### Field of the Invention

Aspects of the present inventions generally relate to an electronic device having modules, an electronic device capable of acting as a main module, an electronic device capable of acting as a sub module, and methods of controlling the electronic devices.

### Description of the Related Art

Japanese Patent Laid-Open No. 2012-514391 recites an example of a module exchange type electronic device configured by removable modules (an image sensor module, a power module, a recording module, and the like).

In the case of a module exchange type electronic device configured by one main module and sub modules, even if a connecting order of the sub modules changes, it is desirable for there to be no change in a function or service that the electronic device provides. However, in practice because transmission signal quality, power supply efficiency, electromagnetic interference (EMI), electromagnetic compatibility (EMC) and the like between sub modules exert an influence on an electronic device, it is not necessarily the case that the electronic device can provide this function or service regardless of the connecting order. Accordingly, in such a module exchange type electronic device, it is desirable that it can be recognized by the main module what type of sub modules are connected and in which order.

### SUMMARY

According to an aspect of the present invention, an electronic device including a main module and sub modules, an electronic device capable of acting as a main module, or an electronic device capable of acting as a sub module is improved.

According to an aspect of the present invention, there is provided an electronic device, comprising: a main module; sub modules including a first sub module and a second sub module; a setting unit that sets a unique communication address to the first sub module by performing communication between the main module and the first sub module using a common communication address; a changing unit that changes a connection route between the first sub module and the second sub module from a disconnected state to a connected state after the unique communication address is set.

According to an aspect of the present invention, there is provided a method comprising: setting a unique communication address to a first sub module by performing communication between a main module and a first sub module using a common communication address; and changing a connection route between the first sub module and a second sub module from a disconnected state to a connected state after the unique communication address is set.

Further features and aspects of the present invention will become apparent from the following description of exemplary embodiments.

### BRIEF DESCRIPTION OF THE DRAWINGS

FIGS. 1A through 1D are views that illustrate an example in which an electronic device 100 is configured by a main module 101 and one sub module.

FIGS. 2A through 2B are views that illustrate an example in which the electronic device 100 is configured by the main module 101 and sub modules.

FIG. 3 is a block diagram which illustrates an example of components of the main module 101.

FIG. 4A is a block diagram which illustrates an example of components of an external I/O module 401.

FIG. 4B is a block diagram which illustrates an example of components of a power module 411.

FIG. 5 is a view for describing an example of communication that is performed between the main module 101 and sub modules.

FIG. 6 is a view that illustrates an example of a table in which information that illustrates a correspondence relationship of a module type and a connectable order is registered.

FIGS. 7A through 7G are views for illustrating an overview of a module recognition process.

FIG. 8 is a flowchart for illustrating the module recognition process.

### DESCRIPTION OF THE EMBODIMENTS

The drawings, which are incorporated in and constitute a part of the specification, illustrate exemplary embodiments, features, and aspects of the present invention.

### First Embodiment

An electronic device 100 in the first embodiment is a module exchange type electronic device configured by removable modules. The removable modules include one main module and one or more sub modules. The main module is an electronic device that is capable of acting as the main module, and each sub module is an electronic device that is capable of acting as a sub module.

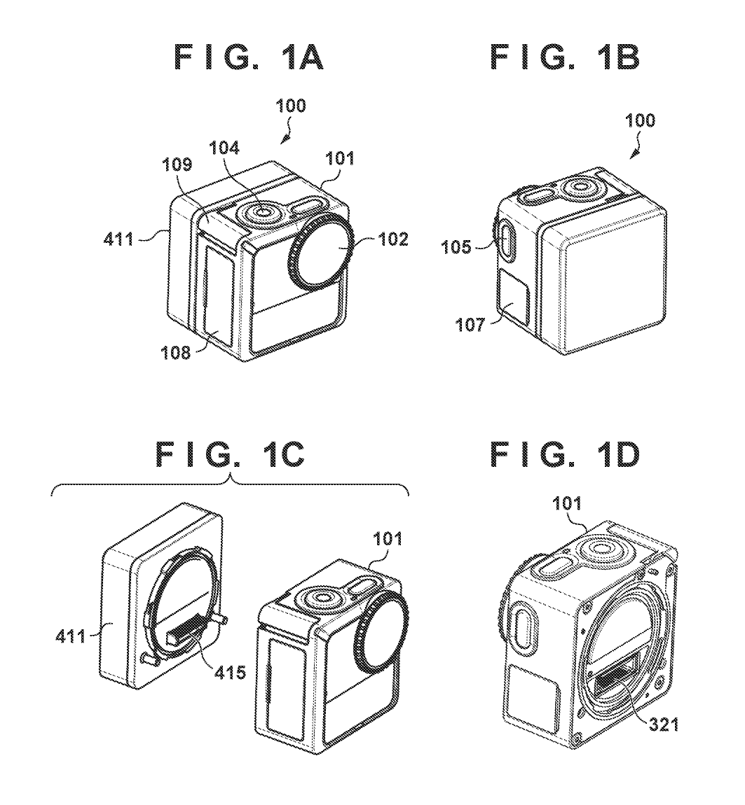

Referring to FIG. 1A, FIG. 1B, FIG. 1C, and FIG. 1D, description is given of an example in which the electronic device 100 is configured by a main module 101 and one sub module. With FIG. 1A, FIG. 1B, FIG. 1C, and FIG. 1D, description is given of an example where a power module 411 as the one sub module is connected to the main module 101. FIG. 1A is a perspective view of a case where the electronic device 100 is seen from a front side (main module 101 side), and FIG. 1B is a perspective view of a case where the electronic device 100 is seen from a rear side (power module 411 side). FIG. 1C is a view illustrating a state where the power module 411 is separated from the main module 101, and FIG. 1D is a perspective view of a case where the main module 101, from which the power module 411 has been removed, is seen from a rear side. In the first embodiment, description is given of an example where the main module 101 is an electronic device that can act as an image capturing apparatus (for example: a digital camera). Furthermore, in the first embodiment, description is given of an example where the power module 411 is an electronic device that can act as a power supply apparatus for supplying power to the main module 101 and sub modules different to the power module 411.

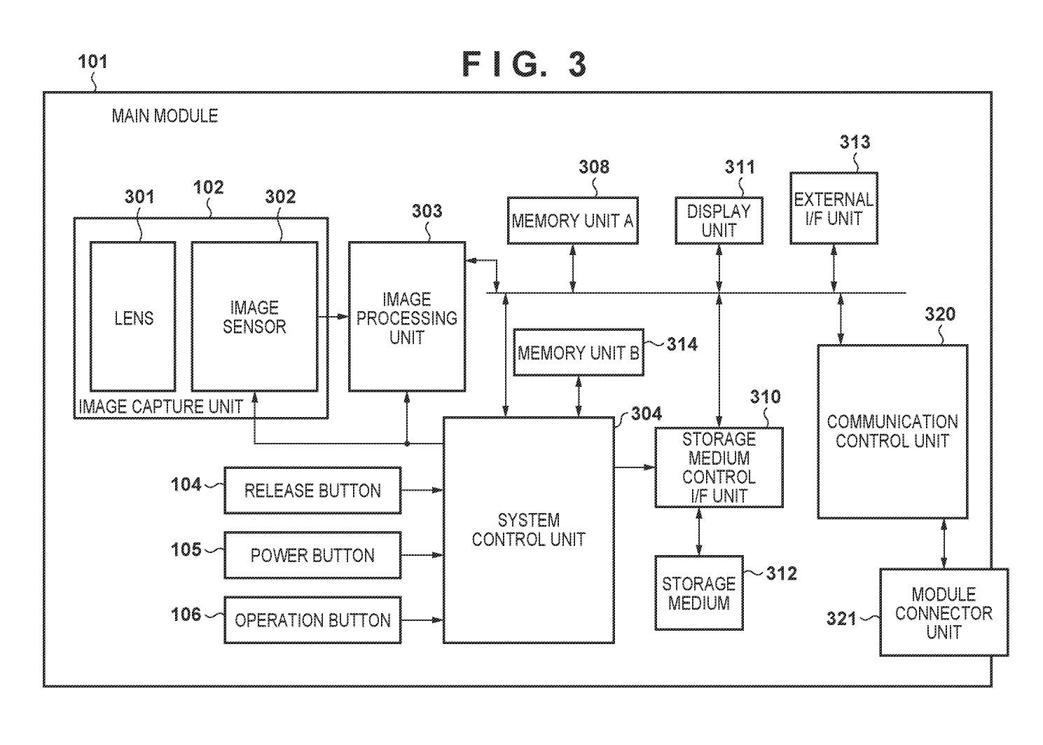

The main module 101 has an image capture unit 102. As illustrated in FIG. 3, the image capture unit 102 has an image sensor 302 for generating an image signal corresponding to an optical image of a subject, and a lens unit 301 for guiding light from the subject to the image sensor 302. A release button 104 is provided on a top surface portion of the main module 101. The release button 104 is capable of a two-stage pressing operation (a half press and a full press). When a user performs a half press operation of the release button 104, preparation operations for image capturing (including a light metering operation and a distance measurement operation) are started. When the user further performs a full press operation of the release button 104, an image capturing operation is started, and image data generated by this image capturing operation is recorded in a storage medium 312 (FIG. 3) in a storage chamber 107.

A power button 105 for inputting power for the main module 101 is provided on a side surface portion of the main module 101. A jack for signal input/output is also provided, and is covered by a jack cover unit 108 for protection. By opening the jack cover unit 108, a user can connect an external apparatus to an external interface unit 313 (FIG. 3). The power module 411 is connected to the back portion of the main module 101. The user can remove the power module 411 by performing an operation for causing a lock member 109 to rotate from a lock position to a lock release position.

A module connector unit 321 for making a connection with a sub module is arranged on a back portion of the main module 101. A module connector unit 415 for making a connection with the main module 101 or another sub module is arranged on a front surface portion of the power module 411. When the power module 411 is connected to the main module 101, the module connector unit 321 and the module connector unit 415 fit.

Note that sub modules that can be connected to the main module 101 include the follow modules, for example.

A power module that has a power source (a primary battery or a secondary battery) and supplies power to another sub module and the main module 101.

An external I/O (input/output) module having a connector for communicating with an external apparatus.

An NFC (Near Field Communication) module for performing short-range wireless communication.

A communication module for sending and receiving data by wireless communication with an external apparatus.

A speaker module for outputting music or an operation sound.

A microphone module for inputting audio.

A large capacity recording module for saving data exceeding the capacity of a storage medium.

A display module in which a liquid crystal display apparatus (for example, a liquid crystal display apparatus) or the like is provided.

A cooling unit for heat accumulation of heat generated by the main module 101 or a sub module.

However, sub modules are not limited to that exemplified in the first embodiment. Regardless of the functions that an apparatus has, it can be configured as a sub module if it is an apparatus that can be connected to the main module 101 or another sub module.

A user can select a sub module from these sub modules, and use the selected sub module after attaching it to a back portion of another sub module or the main module 101. Further connecting to a back surface of an attached sub module is also possible depending on the type of the sub module. A serial communication connection as with a daisy chain is achieved between a sub module connected to the back surface of the main module 101 and a sub module further connected to the back surface thereof.

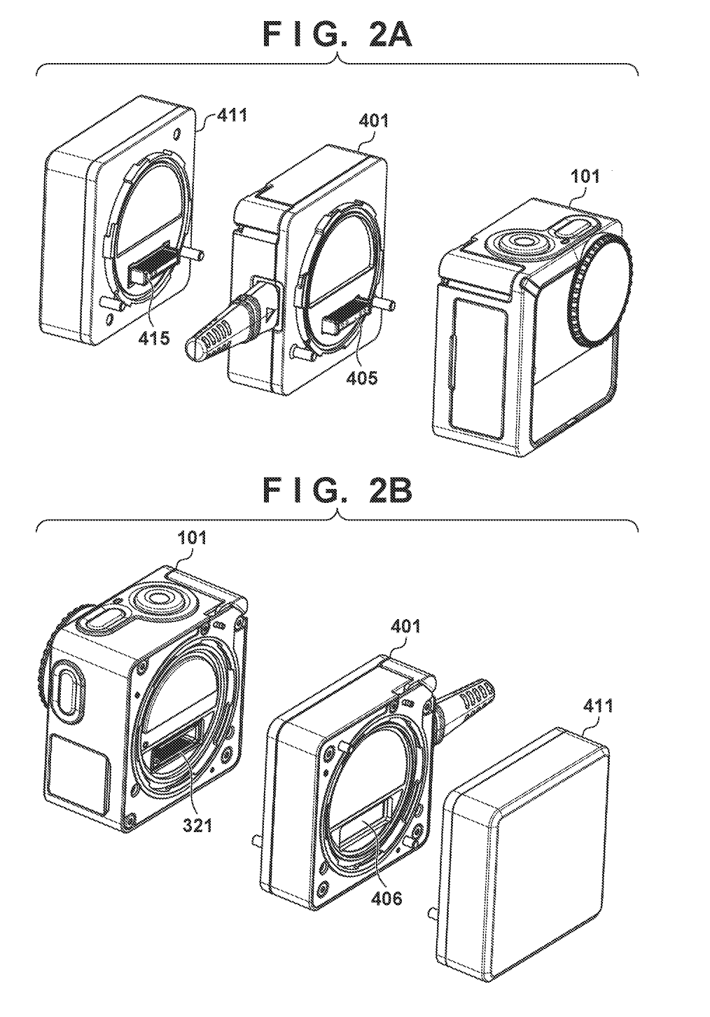

Next, with reference to FIG. 2A and FIG. 2B, description is given of an example in which the electronic device 100 is configured by the main module 101 and sub modules. With FIG. 2A and FIG. 2B, description is given of an example where an external I/O module 401 and the power module 411 are connected to the main module 101 as the sub modules. FIG. 2A is a perspective view of a case where the electronic device 100 is seen from a front side (main module 101 side), and FIG. 2B is a perspective view of a case where the electronic device 100 is seen from a rear side (power module 411 side).

A module connector unit for making a connection between modules is provided in the external I/O module 401, similarly to the main module 101 and the power module 411. A module connector unit 405 is a preceding connection unit for connecting with the main module 101 which is positioned preceding the external I/O module 401. In addition, a module connector unit 406 is a subsequent connection unit for connecting with the power module 411 which is positioned more subsequent than the external I/O module 401. The main module 101 and respective sub modules are connected by using these module connector units 321, 405, 406, and 415.

Next, with reference to FIG. 3, description is given for an example of components of the main module 101.

In FIG. 3, the image capture unit 102 has the image sensor 302 for generating an image signal corresponding to an optical image of a subject, and the lens unit 301 for guiding light from the subject to the image sensor 302. An image signal generated by the image sensor 302 is supplied to an image processing unit 303. The image processing unit 303 generates image data (may be still image data or moving image data) from the image signal from the image capture unit 102. The image data generated by the image processing unit 303 may be encoded by a predetermined encoding method (lossless compression encoding method, lossy compression encoding method, or the like).

A system control unit 304 has a memory storing a program for controlling all the components of the main module 101, and a processor for executing the program to control all the components of the main module 101. The processor included in the system control unit 304 is a hardware processor, for example.

A memory unit A 308 temporarily stores image data generated by the image processing unit 303, and image data read from the storage medium 312. A storage medium control interface unit 310 performs a process (recording process) for reading image data from the memory unit A 308 and writing this image data to the storage medium 312, and a process (reproduction process) for reading image data from the storage medium 312 and writing this image data to the memory unit A 308. The storage medium 312 is a storage medium that has a non-volatile semiconductor memory or the like, and can be removed from the main module 101. A display unit 311 displays information indicating a state of the main module 101 to thereby convey the state of the main module 101 to a user. The external interface unit 313 is a communication interface for communicating with an external apparatus such as an external computer. A memory unit B 314 stores, for example, a result of computation by the system control unit 304.

Information relating to a driving condition of the main module 101 that is set by a user using an operation button 106 is sent to the system control unit 304. The system control unit 304 performs control of the main module 101 overall, based on this information. A communication control unit 320 is connected to the system control unit 304 and the module connector unit 321. Furthermore, the communication control unit 320 is communicably connected to all sub modules directly or indirectly connected to the main module 101, via a communication terminal of the module connector unit 321. The communication control unit 320 can communicate with a communication control unit of each sub module, as described later.

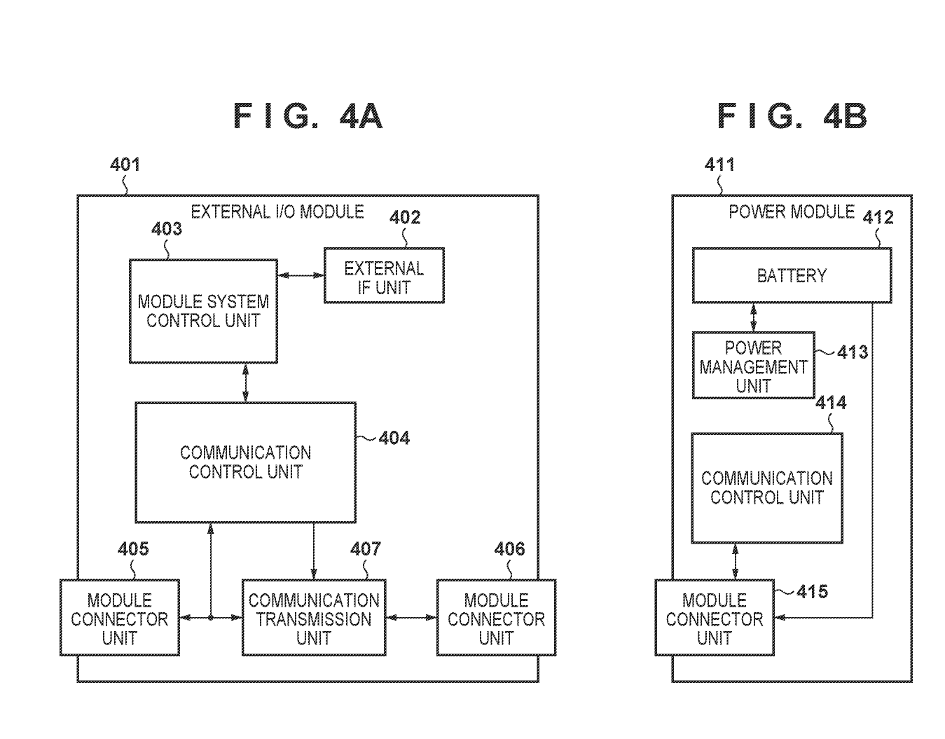

Next, with reference to FIG. 4A and FIG. 4B, description is given for an example of internal configurations of two sub modules of differing types. FIG. 4A is a block diagram which illustrates an example of components of the external I/O module 401. FIG. 4B is a block diagram which illustrates an example of components of the power module 411.

In FIG. 4A, the external I/O module 401 has an external I/F unit 402 for connecting with an external apparatus, and a module function thereof is realized by a module control unit 403. A communication control unit 404 performs a communication process for realizing a communication function with the main module 101 or another sub module. The module connector unit 405 and a module connector unit 406 are connectors for connecting with the main module 101 or another sub module. The module connector unit 405 is a preceding connection unit for making an electrical connection with a module that is preceding it (a side closer to the main module 101). The module connector unit 406 is a subsequent connection unit for making an electrical connection with a module that is subsequent to it (a side further from the main module 101). A communication transmission unit 407 functions as a change unit for changing whether to activate or deactivate a function for conveying to the module connector unit 406 a signal transmitted from the module connector unit 405. In other words, the communication control unit 404 performs communication addressed to its own address via the module connector unit 405 which is the preceding connection unit to change the state (a disconnected state (deactivated) or a connected state (activated) of a connection route between the preceding connection unit and a subsequent connection unit) of the communication transmission unit 407.

In FIG. 4B, the power module 411 has a battery 412 for supplying power to the main module 101 and another sub module. Management of power supplied by the battery 412 is performed by a power management unit 413. In addition, similarly to the external I/O module 401, the power module 411 has the module connector unit 415 and a communication control unit 414 for realizing communication with the main module 101. Note that power supplied from the battery 412 is supplied to the main module 101 or respective sub modules via the module connector unit 415. The power module 411 is a terminating module and thus does not need configurations corresponding to the module connector unit 406 which is for connecting with a subsequent sub module, and the communication transmission unit 407 which is for relaying between a preceding module connector unit and a subsequent module connector unit.

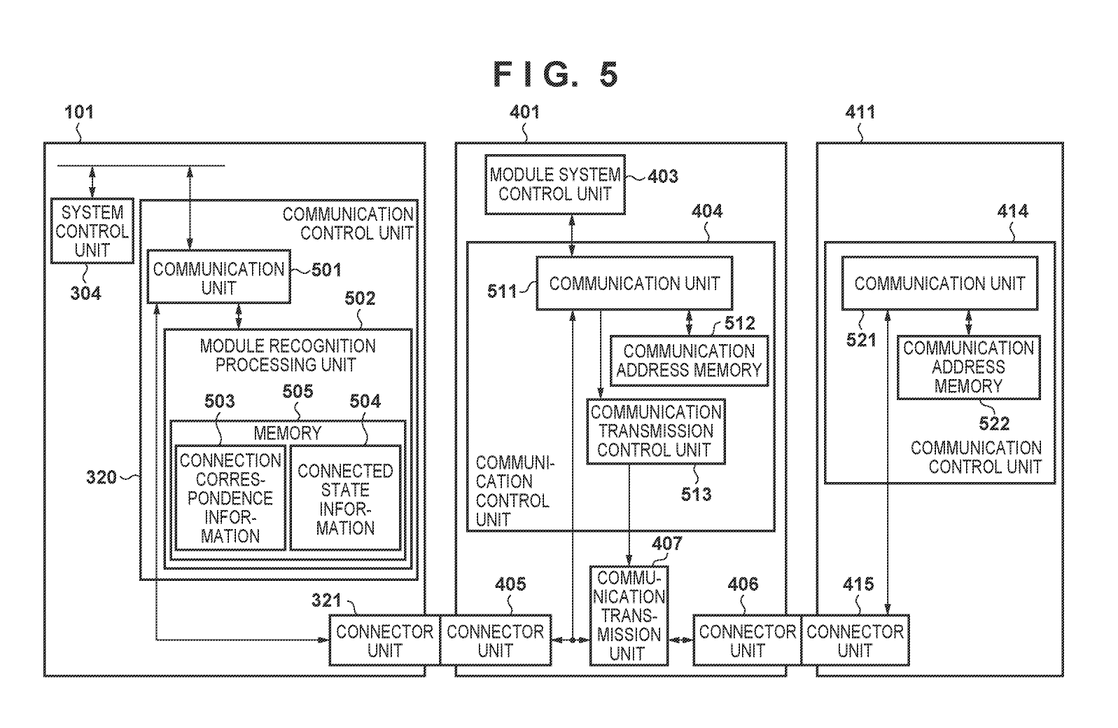

Next, with reference to FIG. 5, description is given of an example of communication that is performed between the main module 101 and sub modules. FIG. 5 illustrates a state where the main module 101, the external I/O module 401, and the power module 411 are connected.

The main module 101 and the respective sub modules are electrically connected by the module connector units provided therein, and realize communication by communication control units for the respective modules. The communication control unit 320 of the main module 101 has a communication unit 501 for generating a communication waveform based on a predetermined communication format, and a module recognition processing unit 502 for recognizing a sub module connected to the main module 101. A memory 505 of the module recognition processing unit 502 stores connection correspondence information 503 and connected state information 504. Here, the connection correspondence information 503, for example, includes information used to determine whether a connecting order for respective sub modules connected to the main module 101 satisfies a predetermined condition. The connected state information 504, for example, includes information regarding types of the respective sub modules connected to the main module 101, and information regarding the connecting order for the respective sub modules.

The communication control unit 404 of the external I/O module 401 includes a communication unit 511 for generating a communication waveform, and a communication address memory 512 for storing an address used for specifying a communication partner. It is assumed that the communication control unit 320 of the main module 101 uses a communication address to perform communication. If this communication address is the same as that stored in the communication address memory 512 of the external I/O module 401, communication between the main module 101 and the external I/O module 401 is established. Furthermore, the communication control unit 404 has a communication transmission control unit 513 for activating or deactivating the communication transmission unit 407 for transmitting a signal to the module connector unit 406 for connecting to a subsequent sub module. The communication transmission control unit 513 sets activation or deactivation of the communication transmission unit 407 in accordance with communication with the main module 101. Functions of a communication unit 521 and a communication address memory 522 included in the power module 411 are similar to that of the communication unit 511 and the communication address memory 512 included in the external I/O module 401.

The same common communication address is stored as an initial value in the communication address memory 512 and the communication address memory 522. The main module 101 of the first embodiment uses the common communication address set in the sub modules to recognize the type of each connected sub module, and also sets a unique communication address to each sub module. Explanation is given later for a detailed procedure therefor.

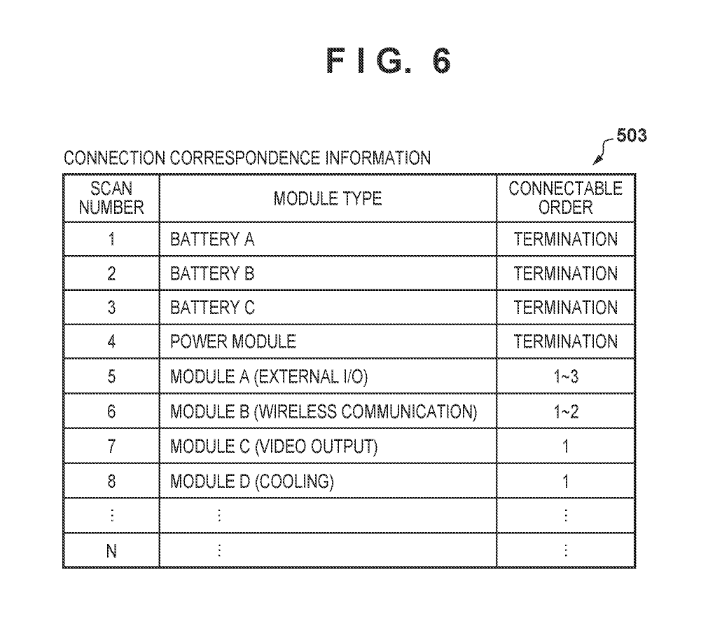

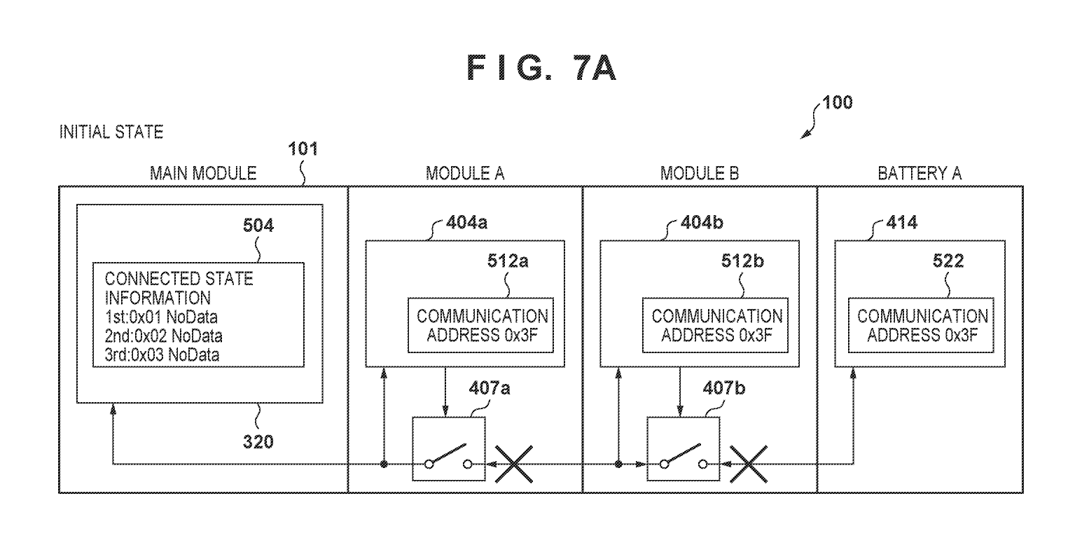

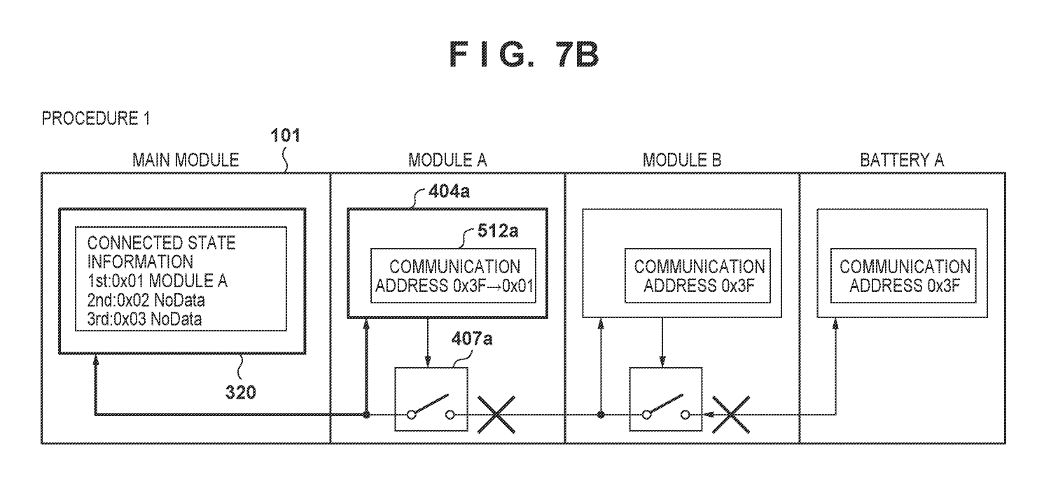

FIG. 6 is a view that illustrates an example of a data configuration of the connection correspondence information 503 that the main module 101 has. In the connection correspondence information 503, a respective “connectable order” in accordance with a module type is recorded. The “connectable order” represents an order (position) at which the sub module can be connected to the main module 101. For example, the type of a sub module that is only permitted to be connected as the most subsequent (referred to as a termination), and the type of a sub module that is only permitted to be connected first immediately after the main module 101 can be determined in accordance with this “connectable order”.

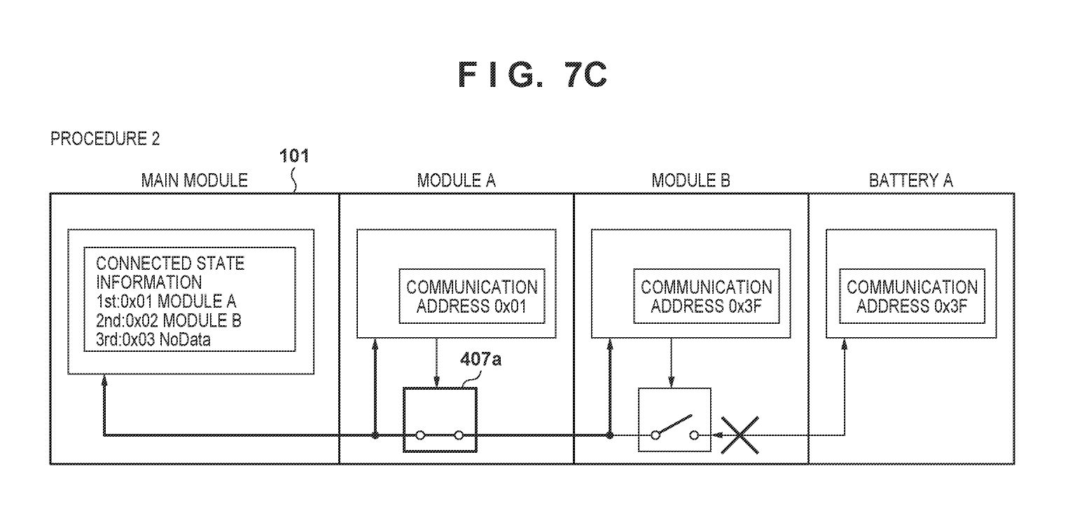

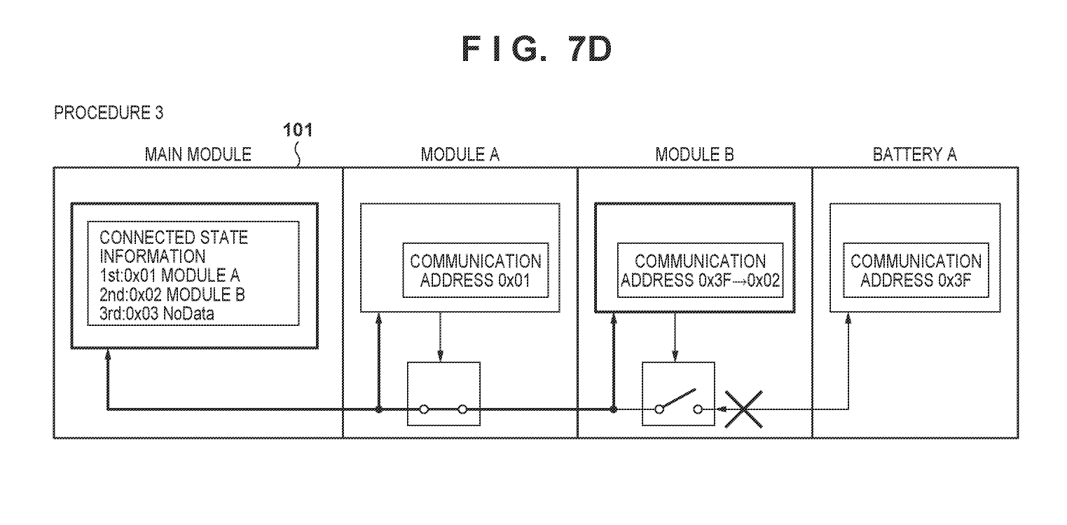

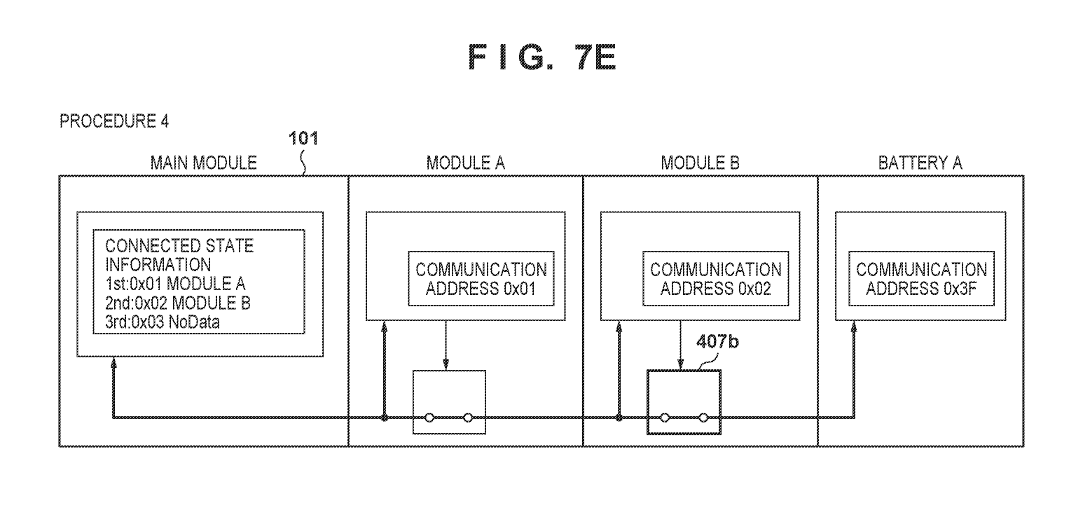

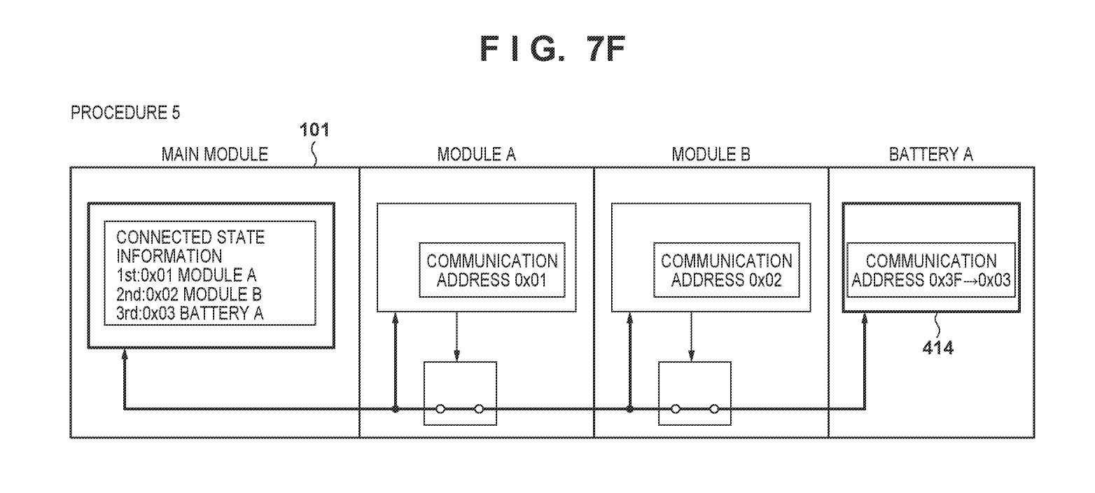

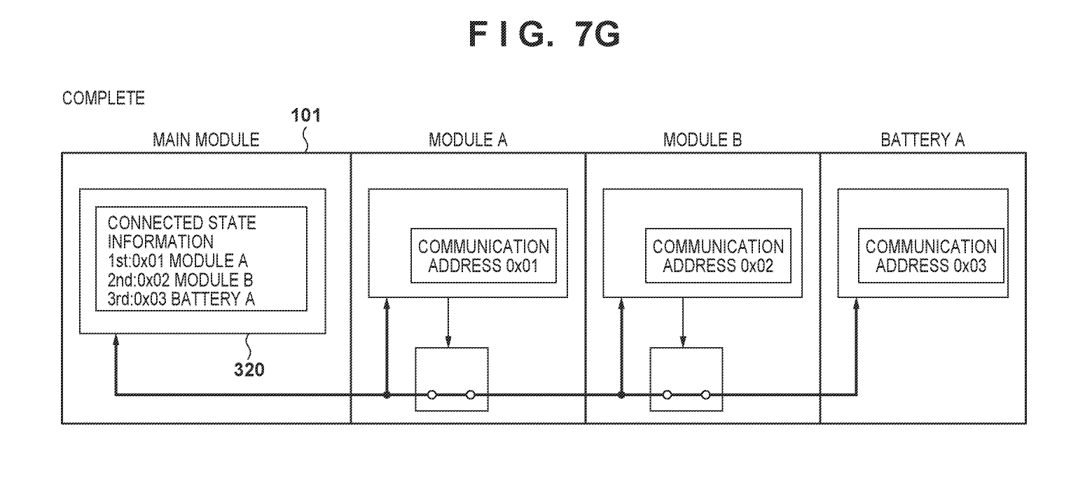

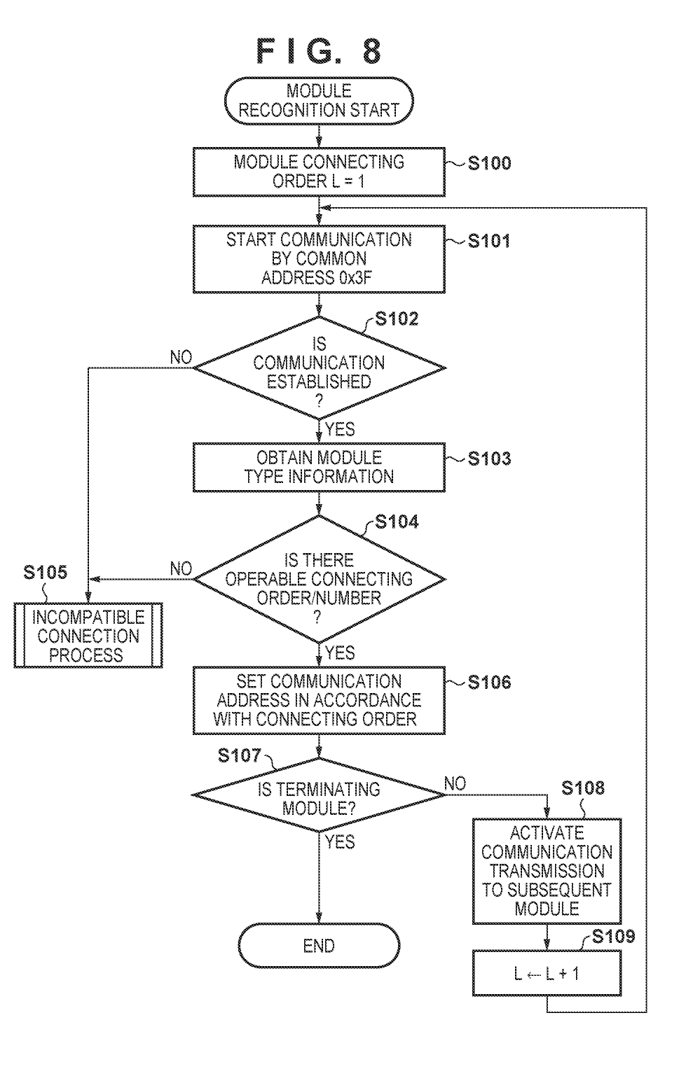

Next, with reference to FIGS. 7A through 7G and FIG. 8, a flow for a module recognition process performed in the first embodiment is described.

First, with reference to FIGS. 7A through 7G, an overview of a communication operation in the module recognition process is described. The electronic device 100 has a configuration in which the main module 101 and one or more sub modules are connected in series. In FIGS. 7A through 7G, a case where three sub modules are connected to the main module 101 is envisioned. It is assumed that respective names of the sub modules are “module A”, “module B”, and “battery A” in an order from closest to the main module 101, and that they are connected in this order. FIG. 7A illustrates an initial state before the module recognition process, and FIG. 7B through FIG. 7G illustrate a procedure for the module recognition process. In FIG. 7A, information (connected state information) indicating a connected state of a module is not recorded in the connected state information 504 of the main module 101. In addition, a communication transmission unit 407a and a communication transmission unit 407b of the module A and the module B are both in a deactivated state, and a communication transmission to a subsequent sub module is in a cutoff state (a disconnected state). In other words, in the electronic device 100, the one or more sub modules connected in series are capable of communication by the common communication address in the initial state, and a connection route between a preceding sub module and a subsequent sub module is in a disconnected state.

In the state of FIG. 7B, the communication transmission unit 407a is in a deactivated state. Accordingly, what can electrically communicate with the communication control unit 320 of the main module 101 is a communication control unit 404a of the module A first connected immediately after the main module 101. In this state, by communication that uses the common communication address between the main module 101 and one sub module, a unique communication address is set for the one sub module. For example, the communication control unit 320 starts communication by using a common communication address 0x3F set as an initial value for each module. Because the communication address 0x3F matches the initial value of the communication address stored in a communication address memory 512a of the module A, the communication control unit 404a returns a communication response. By this, communication is established between the communication control unit 320 of the main module 101 and the communication control unit 404a of the module A. Once communication is established, the main module 101 queries the module A as to the type of the module that is the communication partner. Having received the query, the module A informs the main module 101 that it is “module A”. By this informing, the main module 101 recognizes that the module connected first is the “module A”.

Furthermore, the main module 101 performs communication with the module A, and changes the communication address stored in the communication address memory 512a of the module A to 0x01. Note that, in the first embodiment, 0x01 is a unique communication address allocated to the module connected first. Subsequently, the main module 101 can use the communication address 0x01 to thereby perform communication with only the “module A” that is the first module. Subsequently, the main module 101 activates the communication transmission unit 407a of the module A in accordance with communication. In other words, after the unique communication address is set, the connection route for the one sub module is changed from the disconnected state to the connected state. By this, as illustrated by FIG. 7C, the communication control unit 320 of the main module 101 can perform communication with the communication control unit 404a of the “module A” which is first, and the communication control unit 404b of the “module B” which is the second module connected subsequent to the module A.

In this state, in FIG. 7D the main module 101 uses the common communication address 0x3F to perform communication similarly to in FIG. 7B. Accordingly, communication with the communication control unit 404b of the “module B” which is the module connected second is established, and the main module 101 recognizes, in accordance with the module type query, that the second module is the “module B”. Furthermore, the main module 101 changes the communication address of the module B to the communication address 0x02 which is allocated to the second module, and activates the communication transmission unit 407b of the module B as illustrated in FIG. 7E. In this way, the communication control unit 320 of the main module 101 can communicate with the “module A” that is first, the “module B” that is second, and a further subsequent third module.

Similarly in FIG. 7F the main module 101 performs a recognition process. As a result, the main module 101 recognizes that the third module is the “battery A”, and assigns the communication address 0x03. As is illustrated with the connection correspondence information 503 of FIG. 6, because the battery A is a module that is only connected to a termination, it is understood that this battery A is a final stage module, and the series of recognition processes ends. In this way, as illustrated in FIG. 7G, types and orders of modules that are connected subsequently are recorded in the connected state information 504 of the main module 101. In addition, unique communication addresses are set to the one or more sub modules connected in series to the main module 101.

Next, with reference to the flowchart of FIG. 8, description is given for the module recognition process that is described above.

Firstly, the module recognition processing unit 502 defines a number L that indicates a connecting order of a module that is to be recognized. Here, L=1 indicates that a sub module that is to be recognized currently is the first module connected immediately after the main module 101 (step S100). Next, the module recognition processing unit 502 performs communication using the common communication address 0x3F (step S101). If communication is established using the common communication address 0x3F (YES in step S102), it means that an unrecognized sub module is connected to the L-th connection location. The module recognition processing unit 502 queries for module type information in accordance with communication with the unrecognized sub module, and recognizes the type of the sub module in accordance with a reply to the query (step S103). In this way, before the connection route is changed to the connected state, in accordance with communication that uses the common communication address between the main module 101 and one sub module, the type of the one sub module is recognized.

The module recognition processing unit 502 sets an order in which an unique communication address is assigned as the connecting order for a sub module, and determines the appropriateness of the connecting order based on the type recognized in step S103. In other words, the module recognition processing unit 502 determines, based on the “connectable order”, whether the connecting order of a recognized sub module satisfies the predetermined condition based on the “connectable order”. In a case where it is determined that the predetermined condition is not satisfied (a case where the connecting order is inappropriate) (NO in step S104), the module recognition processing unit 502 performs an incompatible connection process (step S105).

In the incompatible connection process of step S105, the module recognition processing unit 502 causes the operation for setting a unique communication address to the sub module to end. Alternatively, forced termination of the electronic device 100 may be performed. Alternatively, display of a warning to a user may be performed. Note that a similar incompatible connection process is executed when communication is not established in step S102. In addition, in a case where it is determined that the number of sub modules for which unique communication addresses have been set exceeds a limit number (NO in step S104), the module recognition processing unit 502 also ends setting of unique communication addresses to sub modules (step S105).

When the predetermined condition is satisfied, the module recognition processing unit 502 sets a unique communication address in accordance with the connecting order to the recognized module (step S106). Subsequently, when performing communication with respect to this sub module, the communication address allotted in step 5106 is used. In this way, by assigning a unique communication address for each sub module after recognizing the sub module using the common communication address, communication between the main module 101 and the module is possible even if modules of the same type are connected. In other words, when a communication address is caused to be held for each module type, it is not possible to specify each sub module in a state where sub modules of the same type are connected. Meanwhile, as in the first embodiment, when a unique communication address is set before causing communication with all modules to be opened, and it is possible to avoid such a state.

Next, the module recognition processing unit 502 determines whether the sub module recognized by the connection correspondence information 503 is a module connected as the termination as with the power module (step S107). In a case where the sub module is not a module connected as the termination (NO in step S107), the module recognition processing unit 502 activates the communication transmission unit 407 of the L-th module (step S108). In the first embodiment, the module recognition processing unit 502 uses a found communication address to instruct a sub module to change a connection route from the disconnected state to the connected state. By this, the module recognition processing unit 502 can communicate with a subsequent sub module (the L+1-th sub module) (step S108). The module recognition processing unit 502 causes L to increase by 1 (step S109), and starts a recognition process for a subsequent sub module (step S101). Meanwhile, in the case where a recognized sub module is a module that is connected as a termination (YES in step S107), the module recognition process ends. Note that, in the example described above, the connection route to a subsequent sub module is set to the connected state in accordance with an instruction from the main module 101, but there is no limitation to this. For example, in a case where the communication control unit 404 recognizes that a unique communication address has been set by the main module 101, the communication control unit 404 may control the communication transmission unit 407 to change the connection route to the connected state.

Note that, in the first embodiment, the “connectable order” is obtained by referring to the connection correspondence information 503 of the main module 101, but it may be obtained in accordance with communication from the sub module itself that is recognized by communication, similarly to the querying of the module type of step S103 in accordance with communication. In such a case, the sub module informs the main module 101 of information indicating a connectable order in addition to its type.

Next, description is given of an example in which the module configuration illustrated in FIGS. 7A through 7G is recognized in accordance with the module recognition process described above.

Firstly, the module recognition processing unit 502 starts recognition of the sub module connected first with L=1. The module recognition processing unit 502 obtains module type information in accordance with communication using the common communication address 0x3F with respect to the sub module connected first. Consequently, the module recognition processing unit 502 recognizes that the sub module connected first is the “module A (external I/O module)”. Here, the “module A” is not a terminating module, and the predetermined condition (for example, L=1) is satisfied. Accordingly, the module recognition processing unit 502 sets a unique communication address (0x01) to the module A, and activates the communication transmission unit 407a.

By activating the communication transmission unit 407a, the module recognition processing unit 502 starts a recognition process of the subsequent sub module. Similar to the case of L=1, the module recognition processing unit 502 recognizes the L=2 (second) sub module as the “module B” in accordance with communication using the common communication address 0x3F, and sets a unique communication address (0x02). Subsequently, the module recognition processing unit 502 activates the communication transmission unit 407b, and starts recognition of the L=3 (third) sub module. The module recognition processing unit 502 recognizes the third sub module as the “battery A” in accordance with communication that uses the common communication address (0x3F). The module recognition processing unit 502 recognizes that the “battery A” is a terminating module from the connection correspondence information 503, and thus sets a unique communication address (0x03) to the “battery A”, and then ends the recognition process by the electronic device 100.

As described above, by the first embodiment, the main module 101 can recognize the connected state of sub modules. Furthermore, the main module 101 can determine whether the connecting order of a respective sub module satisfies a predetermined condition. Consequently, the main module 101 can prompt a user so that sub modules are connected in an order such that transmission signal quality, power supply efficiency, electromagnetic interference (EMI), electromagnetic compatibility (EMC), or the like between sub modules is in a better state for the electronic device 100 which provides a predetermined function or service. Note that, in the example described above, the unique communication addresses are set so as to be increased one by one, but there is no limitation to this. It is sufficient if a communication address assigned to a sub module is unique, and a value that monotonously increases or monotonously decreases in the connecting order of a sub module can be used, for example.

For example, when a sub module needing the exchange of a large amount of data such as image data (including still images or a moving image) is connected with the main module 101, high-speed data communication occurs between the main module 101 and that sub module. When a connection distance between the main module 101 and the sub module increases, routing for the foregoing high speed data communication lengthens, and an undesirable state from the perspective of EMI is entered. Accordingly, it is desirable for usage where the connection distance between the main module 101 and the sub module is shortened in order to have usage in an advantageous situation with respect to EMI. By virtue of the first embodiment, in accordance with the “connectable order” in regard to such a sub module, it is possible to limit a connection to a near connection with the main module 101 such as immediately after the main module 101 or a further one afterward.

### Second Embodiment

The various functions, processes, or methods described in the first embodiment can be realized by a personal computer, a microcomputer, a CPU (central processing unit), a processor, or the like using a program. Below, in the second embodiment, a personal computer, a microcomputer, a CPU (central processing unit), a processor, or the like is referred to as a “computer X”. In addition, in the second embodiment, the program for realizing the various functions, processes, or methods described in the first embodiment is a program for controlling the computer X, and is referred to as a “program Y”.

The various functions, processes, or methods described in the first embodiment are realized by the computer X executing the program Y. In such a case, the program Y is supplied to the computer X via a computer-readable storage medium. A computer-readable storage medium in the second embodiment includes at least one of a hard disk apparatus, a magnetic storage apparatus, an optical storage apparatus, a magneto-optical storage apparatus, a memory card, a volatile memory, a non-volatile memory, or the like. The computer-readable storage medium in the second embodiment is a non-transitory storage medium.

While aspects of the present invention are described with reference to exemplary embodiments, it is to be understood that the aspects of the present invention are not limited to the exemplary embodiments. The scope of the following claims is to be accorded the broadest interpretation so as to encompass all such modifications and equivalent structures.

This application claims priority from Japanese Patent Application No. 2017-068741, filed Mar. 30, 2017, which is hereby incorporated by reference herein in its entirety.

What is claimed is:

1. An electronic device, comprising:
a main module;
sub modules including a first sub module and a second sub module;
a setting unit that sets a unique communication address to the first sub module by performing communication between the main module and the first sub module using a common communication address; and
a changing unit that changes a connection route between the first sub module and the second sub module from a disconnected state to a connected state after the unique communication address is set.

2. The electronic device according to claim 1, wherein operation for setting the unique communication address ends when communication in accordance with the common communication address is not established.

3. The electronic device according to claim 1, further comprising: a recognizing unit for recognizing a type of the first sub module in accordance with communication between the main module and the first sub module using the common communication address, before the connection route is changed to the connected state.

4. The electronic device according to claim 3, further comprising a determination unit that determines, based on the type recognized by the recognizing unit, whether a connecting order of the sub modules satisfies a predetermined condition.

5. The electronic device according to claim 4, wherein, when it is determined by the determination unit that the connecting order does not satisfy the predetermined condition, setting of the unique communication address ends.

6. The electronic device according to claim 4, further comprising an informing unit that informs a user of predetermined information, when it is determined by the determination unit that the connecting order does not satisfy the predetermined condition.

7. The electronic device according to claim 3, wherein, when the type of the first sub module is a terminating module, setting of the unique communication address ends.

8. The electronic device according to claim 1, wherein unique communication addresses assigned by the setting unit to the sub modules monotonously increase or monotonously decrease in accordance with a connecting order of the sub modules.

9. The electronic device according to claim 1, wherein, if a number of sub modules to which a unique communication addresses have been set by the setting unit exceeds a limit number, setting of the unique communication addresses to the sub modules ends.

10. A method comprising:
setting a unique communication address to a first sub module by performing communication between a main module and a first sub module using a common communication address; and
changing a connection route between the first sub module and a second sub module from a disconnected state to a connected state after the unique communication address is set.
